(19) United States
(12) Patent Application Publication
(10) Pub. No.: US 2007/0221459 A1
(43) Pub. Date: Sep. 27, 2007

(54) Spring strut tube assembly

(76) Inventors: Vladimir Kobelev, Attendorn (DE); Andreas Hauger, Attendorn (DE); Jorge Dieter Brecht, Olpe (DE); Klaus Stretz, Hassfurt (DE); Manfred Schuler, Dittelbrunn/Hambach (DE)

Correspondence Address: WYATT, GERBER & O'ROURKE, 99 PARK AVENUE, NEW YORK, NY, 10016, US

(21) Appl. No.: 11/716,810

(22) Filed: Mar. 12, 2007

(30) Foreign Application Priority Data
Mar. 14, 2006 (DE) 102006012086.8-12

(51) Int. Cl. F16F 9/00

(52) U.S. Cl. 188/322.19; 267/259

(57) ABSTRACT

A spring strut tube assembly having an outer container tube, or tubular member and a spring plate. One end of the tube can be closed by a bottom part and the other end of the tube can comprise an aperture and a slid-on spring plate. The tubular member can be produced from a flexibly rolled flat material whose wall thickness is variable in the longitudinal direction. The tube is formed in a direction transverse to the longitudinal direction, and can be welded in the longitudinal direction.

### FIELD OF THE INVENTION

The invention relates to a spring strut tube assembly, more particularly to an outer container tube for a suspension strut. The outer container tube has a tubular structure which, a first end, can be closed by a bottom part and which, at the other end, comprises an aperture. The spring strut tube assembly also includes a slid-on spring plate carried by the outer container tube, which can be connected at the other end. Suspension strut tubes of this type serve as outer tubes or, respectively, container tubes of two-tube suspension struts which are fixed by additional fixing means. For example, fixing means can be provided in the form of welded-on brackets to a wheel carrier and/or to longitudinal or transverse suspension arms of a motor vehicle and which support a helical spring on the spring plates.

Such two-tube suspension struts, in addition to the outer or container tube referred to here, comprise a working cylinder which is held concentrically within the outer tube, as well as a piston rod with a piston. The piston rod projects upwardly from the spring strut tube and is sealed relative to the working cylinder. The lower end can be closed by an inserted or superimposed bottom part. Between the container tube and the working cylinder, a bottom value is positioned via which both the container tube and the working cylinder communicate with one another. At the upper end, the container tube and working cylinder are firmly connected to one another and sealed relative to one another by an annular cover. The annular cover can also serve as a piston rod guide.

The piston comprises a piston valve via which the operating chamber above the piston communicates with the operating chamber below the piston. In the annular chamber between the container tube and the working cylinder, at the upper end, a gas volume is enclosed which is outwardly sealed by the annular cover. Generally, an elastic rubber element can be fixed at the upper end of the piston rod which can support the spring strut in a spring strut dome. Brackets secured to the lower end can be used to bolt on a wheel carrier, so that the suspension strut can be suitable for a McPherson wheel suspension.

### BACKGROUND OF THE INVENTION

It is already known, for the purpose of achieving a lightweight construction, to produce spring strut tubes whose wall thickness varies along their axial length. For this purpose, spring strut tubes are produced by deep drawing.

### OBJECT OF THE INVENTION

It is an object of the present invention to provide a sturdy spring strut tube of lightweight construction which can be produced cost-effectively.

### SUMMARY OF THE INVENTION

A spring strut tube assembly according to the invention includes an outer container tube, such as a tubular member. The tubular member can be produced from a flexibly rolled flat material having a wall thickness that is variable in a longitudinal direction. The tubular member can be formed into a tube in a direction transversely to the longitudinal direction, and welded in the longitudinal direction, i.e., length-wise. Thus, the outer container tube—or tubular member—is provided with a wall thickness that is variable in the longitudinal direction from one end to the other. The process technology of flexible rolling allows the cost-effective production of strips or sheets from a material whose wall thickness is greatly variable (i.e. “rolled flexibly”).

The outer container tube can be comprised of several tube sections, and accordingly can be produced from individual strip portions or sheets, which are cut into lengths, bent into tube members transversely to the direction of rolling, and then welded together along a longitudinal seam. It is also possible and easy to produce cross-sections which are non-uniform along their length. A process of producing such tubular members is described in DE 10 2004 017 343 A1 of the Applicant. More particularly, it is explained that the strip material cut into lengths is first deep-drawn transversely to the longitudinal axis. Thereafter the side edges are cut and the tubular member is bent round and closed by welding. If the side edges form a butt joint along a straight surface line of the tubular member, the welding operation can be carried out particularly advantageously and securely.

One embodiment of the spring strut tube assembly according to the invention provides a tubular member that has a wall thickness which decreases substantially from the closed lower end to the open upper end, and thus allows an advantageous adaptation to the load profile in the built-in, i.e., operational, condition in which bending forces are predominant.

In another embodiment, the wall thickness of the tubular member or outer container tube substantially decreases in such a way that, in the longitudinal direction, the course taken by the resistance moment corresponds to that taken by the bending loads under operational conditions. This results in substantially constant stress conditions in the tubular member in the longitudinal direction when under loaded operation. The load largely consists of bending forces which act on the tubular member.

In a further embodiment, the tubular member comprises at least two cylindrical portions of different diameters, between which transition portions are provided.

In another embodiment, the tubular member (or outer container tube) includes cylindrical portions with smaller diameters at each end of the tubular member and an intermediate cylindrical portion with a greater diameter. This permits sealing (at the top end) and closing (at the bottom end) of sections having reduced diameters where it is preferable to provide a larger inner cross-section for the intermediate portion in the guiding region of the piston.

In a further embodiment of the invention, a tubular member or outer container tube of the spring strut tube assembly is provided having cylindrical portions of different outer diameters. The axes of the cylindrical portions of different outer diameters are offset relative to one another in such a way that the cylindrical portions comprise mantle lines arranged so as to be aligned relative to one another. A weld preferably extends along the aligned mantle lines of the portions with different outer diameters. In this way, the above-mentioned linear butt joint at the tubular member can easily be closed by a linear weld.

According to an alternative embodiment of a spring strut tube assembly according to the invention, the tubular member or outer container tube is provided with cylindrical portions with smaller outer diameters located at the ends of the tubular member. The axes of the smaller cylindrical portions are aligned relative to one another. This geometry is preferred for some applications. It is proposed that the weld extends along a butt joint which is positioned in a radial plane extending through the axes of smaller cylindrical portions at the ends. This, too, allows an easy welding operation.

In another embodiment, one of the two smaller cylindrical portions positioned at the ends of the tube comprises a smaller outer diameter than the other one of the two smaller cylindrical portions. In addition, the smaller of the two smaller cylindrical portions form a continuous circumferential diameter step with an intermediate cylindrical portion having a greater outer diameter. The spring plate can rest on this continuous diameter step and be supported uniformly, form-fittingly and positively.

According to a further embodiment of the invention, a spring strut tube assembly is provided wherein the spring plate comprises a material having a variable wall thickness. Specifically, a greater wall thickness can be provided in the region of connection with the tube. This measure, too, permits adaptation to anticipated load profiles, while saving material, and achieving a lightweight construction.

In a further embodiment of the invention, a spring strut tube assembly is provided wherein the spring plate has a wall thickness which varies in one direction. The spring plate can be produced from a flexibly rolled flat material, and the flat material can then be subsequently punched and/or cut and deformed. Thus a cost-effective production method for the spring plate is achieved.

Further advantageous embodiments are described in further sub-claims to which reference is hereby made.

### BRIEF DESCRIPTION OF THE DRAWINGS

Several embodiments of the invention are illustrated in the drawings and are described in greater detail below.

FIG. 1 illustrates an outer container tube, or tubular member, of an inventive spring strut tube assembly in a first embodiment in the form of a detail in different illustrations

a) in a first side view

b) in a second side view

c) in a third side view

d) in a first axial view

e) in a second axial view

f) in section A-A according to illustration b

g) in section B-B according to illustration c

h) in an isometric inclined view.

FIG. 2 illustrates a longitudinal section of a device according to FIG. 1f.

FIG. 3 illustrates an enlargement of a longitudinal section of a device according to FIG. 1g.

FIG. 4 illustrates a spring plate of an inventive spring strut tube assembly in the form of a detail in different illustrations

a) in a plan view in the direction of the through-aperture

b) in a first side view

c) in a second side view

d) in a third side view

e) in a fourth side view

f) in a view from below in the direction of the through-aperture

g) in section A-A according to FIG. 1a

h) in section B-B according to FIG. 1a

i) in an isometric inclined view.

FIG. 5 illustrates an enlarged, plan view of a device according to FIG. 4a.

FIG. 6 illustrates an enlarged section according to FIG. 4g.

FIG. 7 illustrates an enlarged section according to FIG. 4a.

FIG. 8 illustrates an inventive spring strut tube assembly according to FIG. 1, with a spring plate according to FIG. 4

a) in a first side view

b) in a second side view

c) in a plan view in the direction of the longitudinal axis

d) in a view from below in the direction of the longitudinal axis

e) in section A-A according to FIG. 8a

f) in an isometric inclined view.

FIG. 9 illustrates an enlarged view of a device according to FIG. 8a.

FIG. 10 illustrates an enlarged view of a section of a device according to FIG. 8e.

FIG. 11 illustrates a longitudinal section of an embodiment of a spring strut tube assembly according to FIG. 2.

FIG. 12 illustrates an enlarged view of an inventive spring strut tube assembly according to FIG. 11 with a spring plate according to FIG. 4.

### DETAILED DESCRIPTION

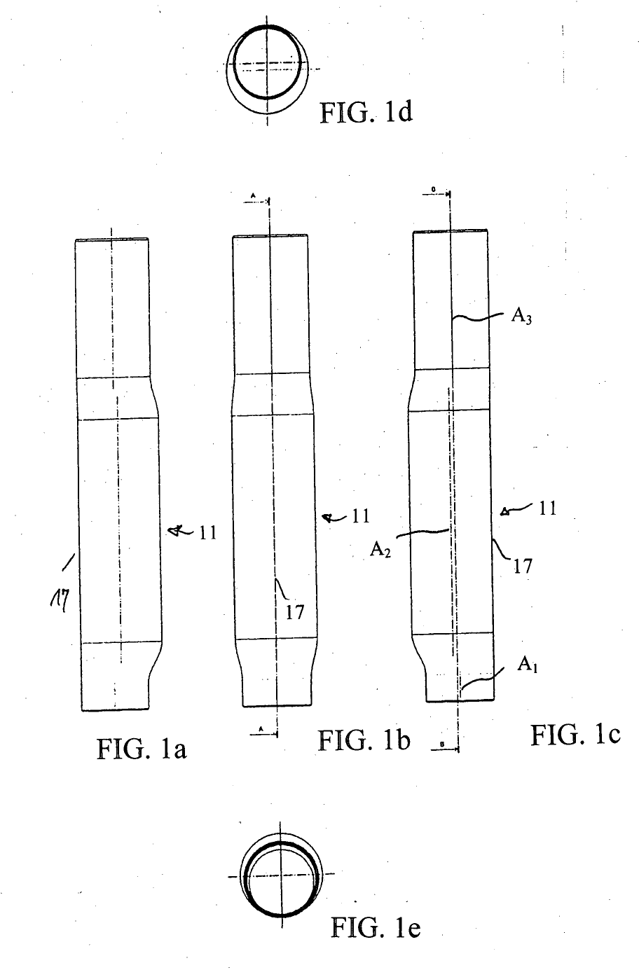

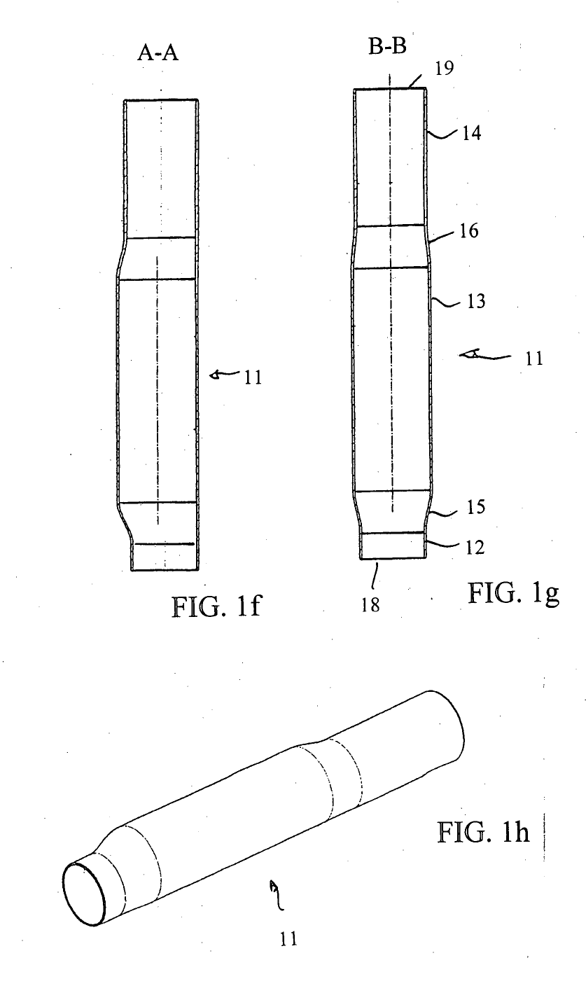

FIG. 1 shows an outer container tube, or tubular member 11, of a spring strut tube assembly according to the invention in different Figures. In the figure, the tubular member 11 has been turned by 180° from a mounted position (shown later) i.e. the tube end shown at the top, generally points downward in the mounted condition and is closed by a bottom part. The tube end shown at the bottom, generally points upward in a mounted position and remains open. An outer container tube, or tubular member 11 can be provided with three cylindrical tube portions 12, 13, 14 which are connected to one another by inclined conical transition portions 15, 16. As shown, a first cylindrical portion 12 is provided with a smaller outer diameter, a second cylindrical portion 13 is provided with a greater outer diameter and a third cylindrical portion 14 is provided with a smaller outer diameter, with the outer diameter of the tubular portion 14 slightly deviating from the outer diameter of the first tubular portion 12. The longitudinal axes of the tubular portions 12, 13, 14 are offset in parallel relative to one another, with the longitudinal axis A1 of the first tubular portion 12 and the longitudinal axis A2 of the second tubular portion 13 being offset in opposite directions, parallel to the longitudinal axis A3 of the third tubular portion 14.

Between the first and second tubular portions 11 and 12, an oblique conical transition portion 15 is shown and between the second and third tubular portions 13 and 14 an oblique conical tubular portion 16 is shown.

“Oblique conical”, such as provided in the oblique conical transition portion 15, describes the outer diameters of the tubular portions which increase and decrease uniformly and at the same rate in the longitudinal direction, whereas the central axis-connecting the centers-forms an angle with one of the mantle lines which extends parallel to the longitudinal axes of the adjoining cylindrical tubular portions.

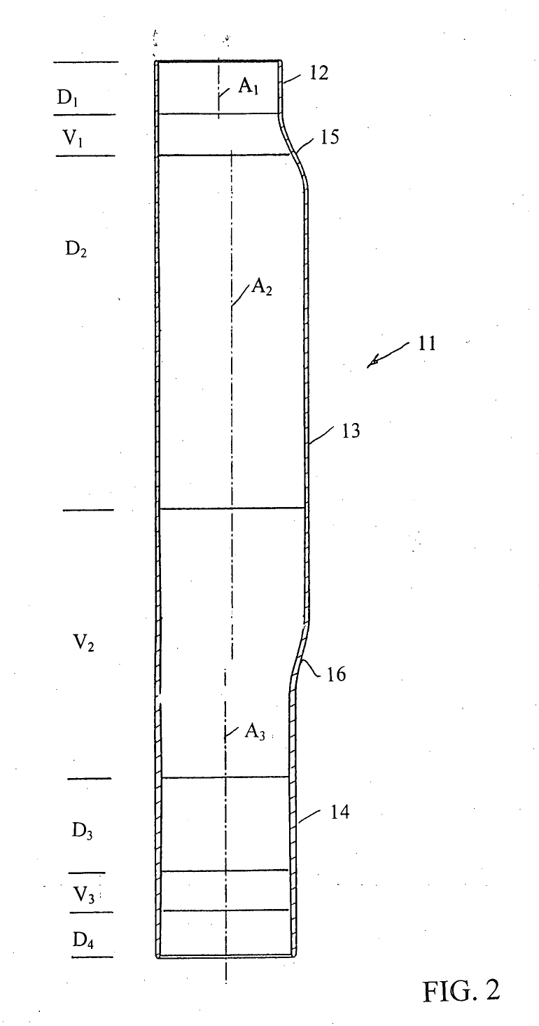

The offset of the longitudinal axes A1, A2, A3 of the cylindrical tubular portions 12, 13, 14 is such that the longitudinal axes form a common plane. In addition, with reference to the longitudinal axis A3 of the mean outer diameter of the first cylindrical portion 12 (as shown in FIG. 1), the longitudinal axis A2 of the cylindrical portion with the greatest outer diameter is offset in parallel in a first direction. In addition, the longitudinal axis A1 of the cylindrical portion with the smallest outer diameter is axially offset in a second opposed direction. As shown in FIG. 2, the first aperture of the tubular member has been given the reference number 18 and the second aperture the reference number 19.

Along the continuously straight mantle line 17 of the tubular member 111 (shown in FIG. 1a on the left and shown in FIG. 1c and If on the right), a weld can be provided for joining the material of the tube in a fabrication process. In a fabrication process of a tube, the material can be first flat-rolled in the longitudinal direction, then cut along the longitudinal edges and subsequently bent into a round, tube shape. The wall thickness of the flexibly rolled material and thus the wall thickness of the resulting tube decreases in the drawing from the top to the bottom. In a mounted position, the wall thickness increases from the top to the bottom, as described further herein in greater detail with reference to the following figures.

In FIGS. 1a to 1c, the outer edges at the transitions from the cylindrical portions to the conical transition portions can be circumferentially continuous, as shown. Similarly, in FIGS. 1f and 1g, the inner edges between the transitions from the cylindrical portions to the conical transition portions are circumferentially continuous, as shown. Alternatively, the transitions can be slightly rounded.

In FIG. 2, one embodiment of a spring strut tube assembly in FIG. 1f is shown, enlarged and oriented in a position as it may be used. It can be seen in this figure that the tubular member 11 (outer container tube) comprises several longitudinal portions of different wall thicknesses, including four different thickness zones (or tube portions) of substantially constant thickness and three intermediate transition portions. The first cylindrical portion 12 is shown as having a first thinnest thickness D1. A portion of the transition portion 15 is shown as having an increasing thickness V1, variable around a circumference. A second portion, shown as having thickness D2, comprises a remainder portion of the transition portion 15 and can be provided as having approximately two thirds of the length of the central cylindrical portion 13. The remainder of the cylindrical portion 13, the transition portion 16, and approximately one third of the length of the cylindrical portion 14 are shown having a continuously increasing variable thickness V2. A third thickness D3 comprises the central portion of the cylindrical portion 14. An adjacent portion with a decreasing variable thickness V3 is also provided. Finally, there follows a portion with a fourth thickness D4 which is smaller than thickness D3 and can be provided as comprising approximately the last third of the last cylindrical portion 14. By way of example, the thickness zones D1, D2, D3, D4 mentioned here in the above sequence can be provided as having thickness of approximately 1.35 mm, 1.5 mm, 2.5 mm and 2.35 mm, respectively. The boundaries between the thickness zones and the transition portions are marked by transverse lines extending between the walls, whereas the transitions between the cylindrical portions and conical portions are not marked.

It can be appreciated, that the wall thickness of the tube can be formed to decrease substantially from one end to the other, such as at a predetermined rate whereby the course of the resistance moment in the longitudinal direction corresponds to the course of bending loads under various circumstances, such as under operational conditions.

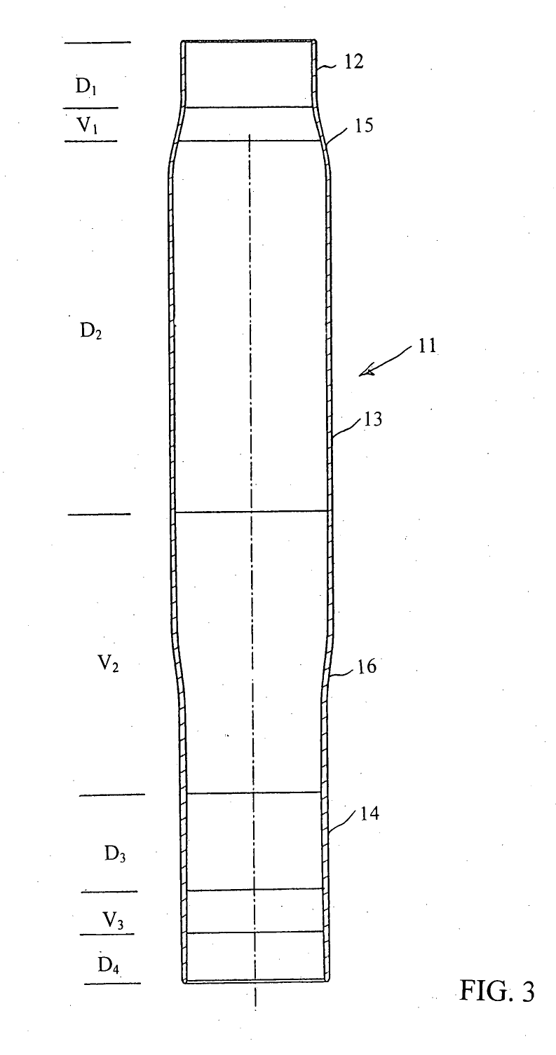

FIG. 3 shows an embodiment of a spring strut tube assembly, such as shown in to FIG. 1g, in an enlarged form. In this embodiment, the boundaries between the thickness zones and the transition portions are marked by transverse lines extending between the walls, whereas the transitions between the cylindrical portions and the conical portions are not emphasised by visible edges. Otherwise reference is made to the description of FIG. 2.

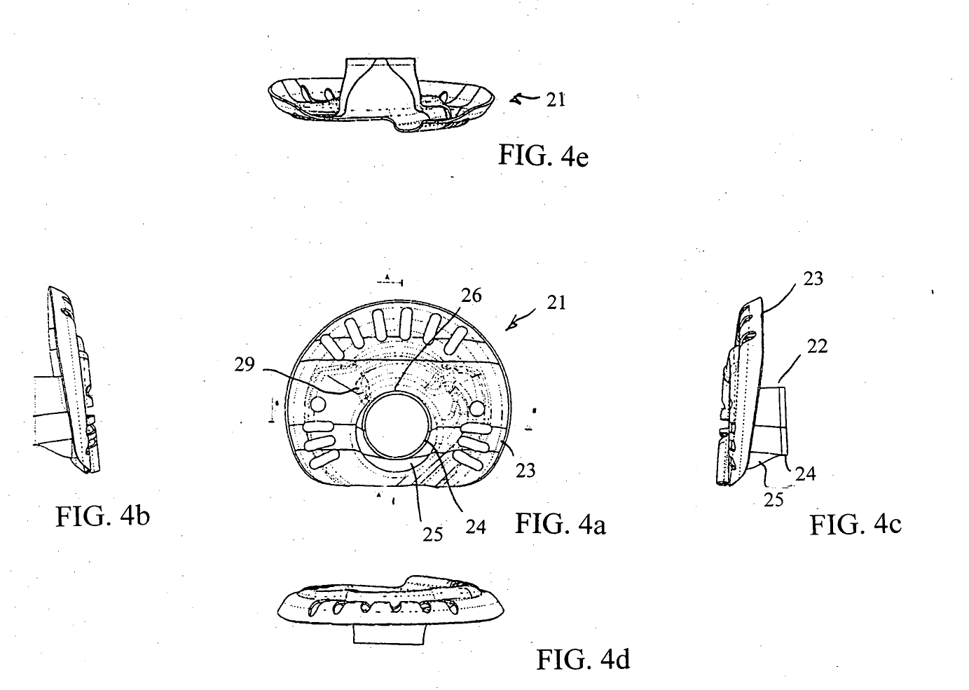

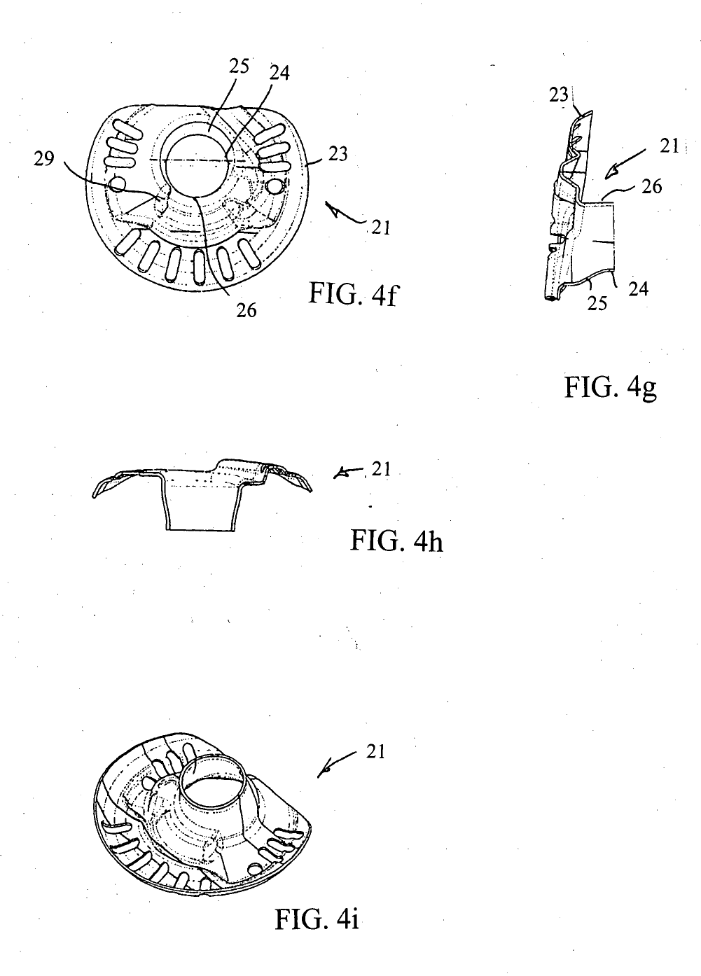

FIG. 4 shows a detail of a spring plate 21 of the spring strut tube assembly mentioned above. The spring plate 21 can be slid onto an outer container tube, or tubular member as shown in FIGS. 1 to 3, and can be connected thereto. The individual illustrations are described below.

The spring plate 21 can comprise a metal plate, a tube-like seat portion 22, and a plate portion 23 which surrounds the latter. The centers of the two latter parts are offset relative to one another. The seat portion 22 comprises a cylindrical portion 24 which can be slid onto the first cylindrical portion 12 of the tube 11. In addition, an oblique conical portion 25 can be positioned in a form-fitting and positive way on the transition cone 15 of the tube 11. When the seat contact is established, an axially supported and rotationally fast connection can be formed in such a way that the sectional line A-A of FIG. 1 coincides with the sectional line A-A of FIG. 4. Accordingly, the cylindrical portion 24 and the conical portion 25 comprise a common linear mantle line 26.

The seat portion 22 is connected to the spring plate 23 which can be positioned symmetrically relative to the sectional plane A-A, but asymmetrically relative to the sectional plane B-B extending perpendicularly thereto. The spring plate 23 surrounds the conical portion 25 of the seat portion 21 and is curved like an annular dish, so that an outer edge points to the free end of the seat portion 22 as shown. The centre of the spring plate (not illustrated) which is offset from the center of the seat portion 22 towards the straight mantle line 26. As shown in the Figures, the spring plate is cut in approximately a straight line for a cross-section view from the side radially opposite the mantle line 17 with reference to the longitudinal axis A1.

The spring plate 21 includes three groups of radial slots 27 and two individual holes 28, which holes 28 are positioned transversely to the sectional plane A-A. The spring plate also includes a formed rotary stop 29 for a helical spring which can be supported on the spring plate.

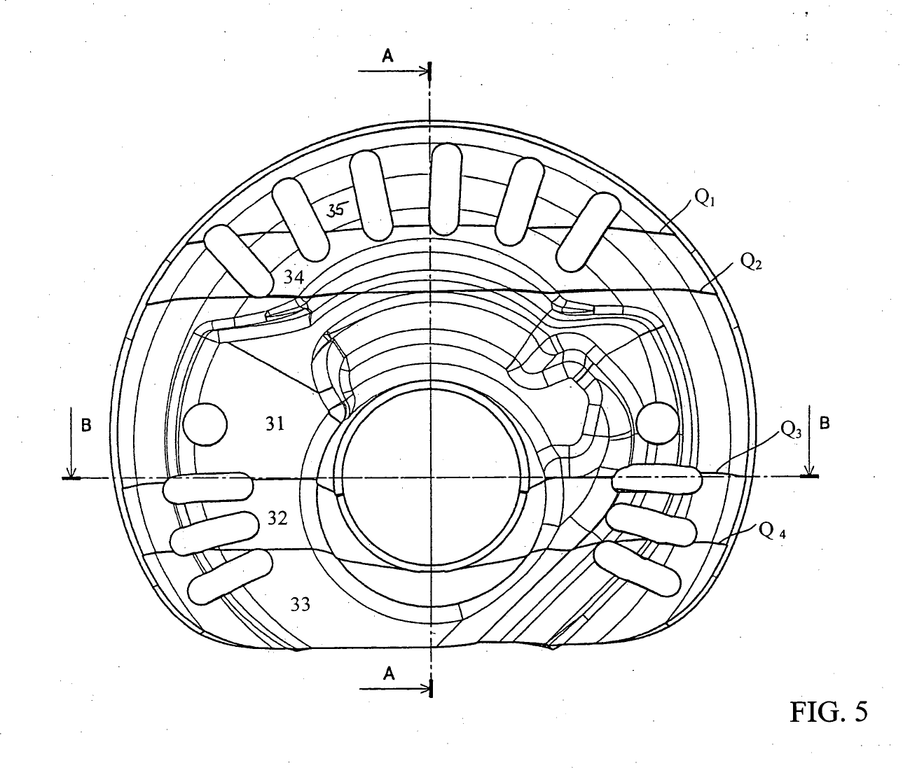

FIG. 5 shows the spring plate according to FIG. 4a in an enlarged form. The following details are visible.

In a fabrication process, the spring plate can be punched out of a rolled flat material after the rolling operation, with the slots and holes being punched out at the same time. Thereafter, the spring plate can be given its final shape by being deep-drawn. Transverse lines Q1, Q2, Q3, Q4 extending transversely to the sectional plane A-A indicate the boundaries between the regions of different thicknesses of the spring plate. Thus, the spring plate comprises a material that can be fabricated from a flexibly rolled material whose direction of rolling coincides with the direction of the sectional plane A-A. Of these several sections, a formed a central region 31 is provided with a constant greatest wall thickness. A transition region 32 is also provided with a decreasing wall thickness. In addition, a region 33 is provided with a first reduced wall thickness. Further, a transition region 34 is provided with a decreasing wall thickness. Finally, a region 35 is provided with a second reduced constant wall thickness positioned in the other direction.

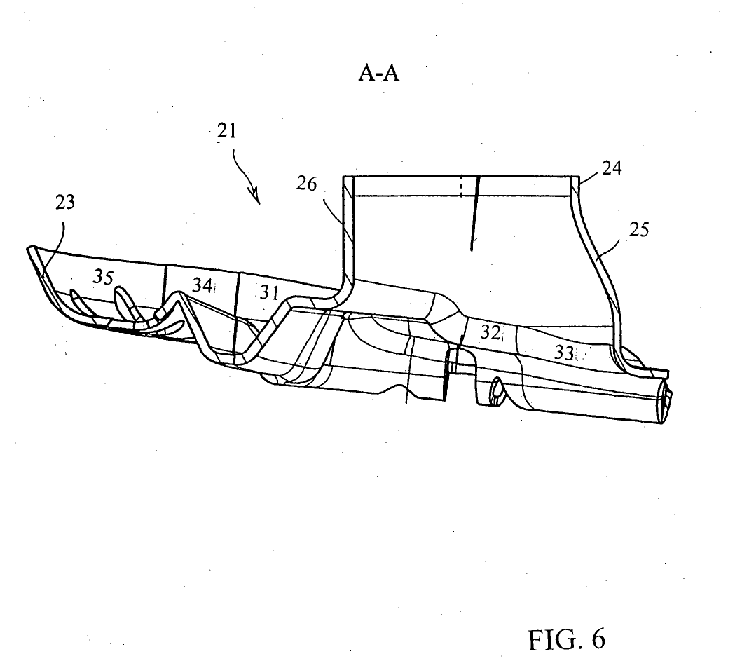

FIG. 6 shows the spring plate in a section according to FIG. 4d. Identical details have been given identical reference numbers. The spring plate is shown in its mounted condition, so that it is easy to see how the cylindrical portion 24 and the conical portion 25 can be slid on to the upper cylindrical portion 12 and the first transition portion 15 of the tube according to FIG. 1.

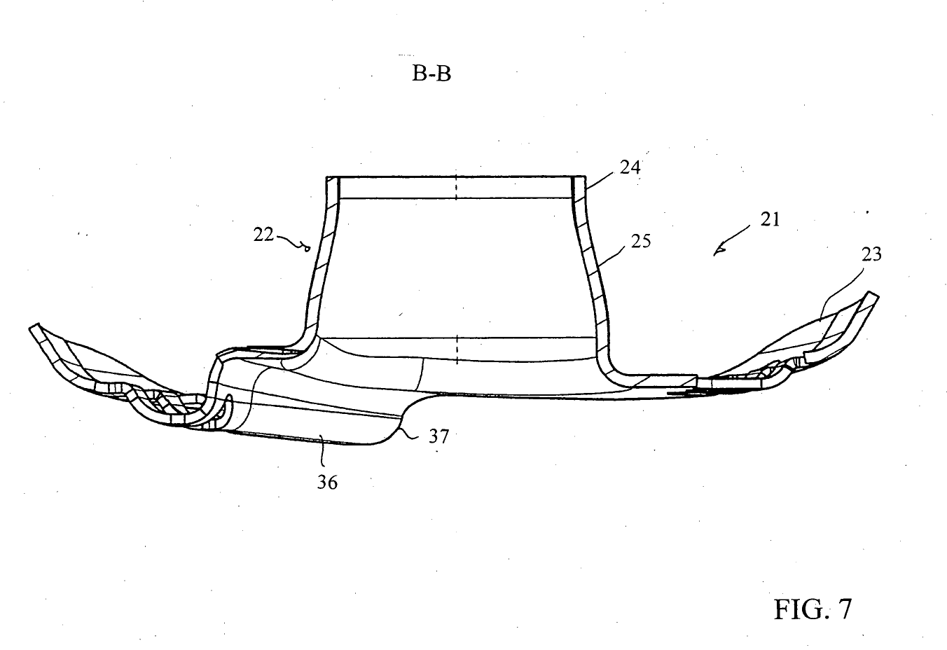

FIG. 7 shows the spring plate according to FIG. 4h in a mounted position. It can be seen how the spring plate, in the position as illustrated here, can be slid on to the tube according to FIG. 3 in order to provide a firm seat. Furthermore, a deep groove 36 in the plate portion 23 is provided for the end of a helical spring which can be supported on the spring plate and at an end stop 37 in the circumferential direction. It is preferable that end stop 37 is positioned in a region of the spring plate with the greatest wall thickness.

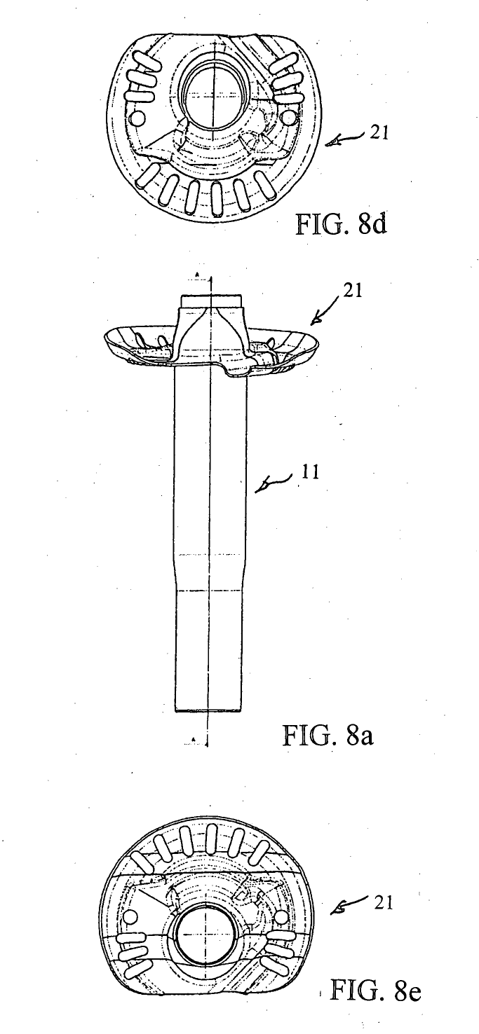

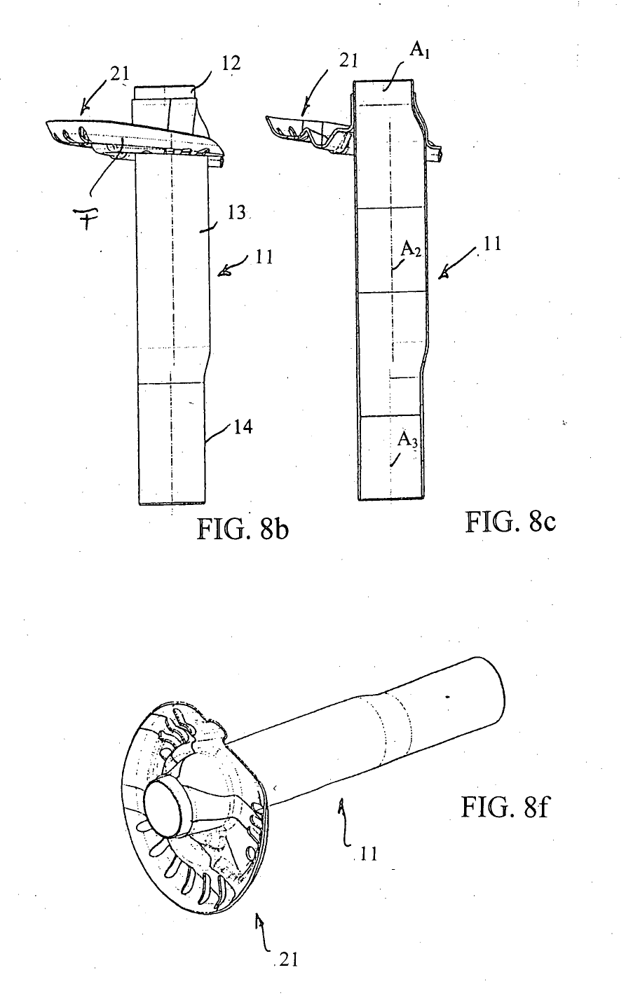

FIG. 8 shows a spring strut tube assembly according to the invention which includes an outer container tube, or a tubular member 11 according to FIG. 1 and a spring plate 21 according to FIG. 4 in a mounted condition. The seat portion 22 of the spring plate 21 is form-fittingly and positively positioned in the axial direction on the cylindrical portion 12 and on the conical portion 15 of the tubular member. In addition, the oblique conical shape provides a form-fitting connection in a direction of rotation. A press fir can be formed between the spring plate 21 and the tubular member 11. Additional spot welds or the like can also be possible. A support plane F of the spring plate as shown in the Figure, and is inclined relative to the longitudinal axes A1 to A3 of the tubular member, which predetermines the position of the helical spring relative to the position of the damper tube. The helical spring can have a straight central axis. Alternatively, it can also have a C-shaped or S-shaped central axis.

The central cylindrical portion 13 and/or the lower cylindrical portion 14 of the tube can be provided with brackets or flanges which can be formed of plate metal. By use of these brackets or flanges, the spring strut tube can be bolted to a wheel carrier or to longitudinal or transverse control arms of a motor vehicle. The lower aperture 19 is preferably closed by a cover (not shown) which can be inserted and held by a press fit or it can be welded. The cover can support an inner tube of a spring strut that is mounted. Sealing means for the inner tube can be provided in the region of the first cylindrical portion 12. After the tube has been closed by welding, the cylindrical portion 14 can be machined on its inside to smooth out the weld or sealing means.

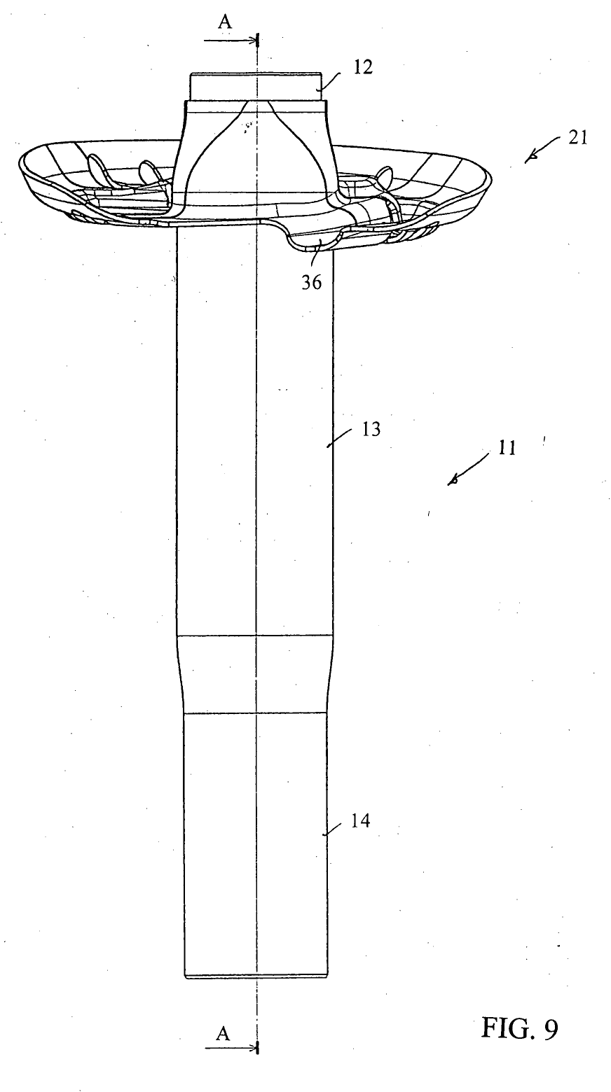

FIG. 9 shows an enlarged form of a spring strut tube assembly according to the invention, as shown in FIG. 8a. Identical details have been given the same reference numbers as in the previous figures. As in FIGS. 1b and 4a, only the transitions between the cylindrical portions and the conical portions have been indicated by visual edges. The spring plate 21 is shown with a deep groove 36 which is open towards the upper end and which is provided for receiving a helical spring. The sectional plane A-A accommodates the longitudinal axes of the cylindrical portions 12, 13, 14.

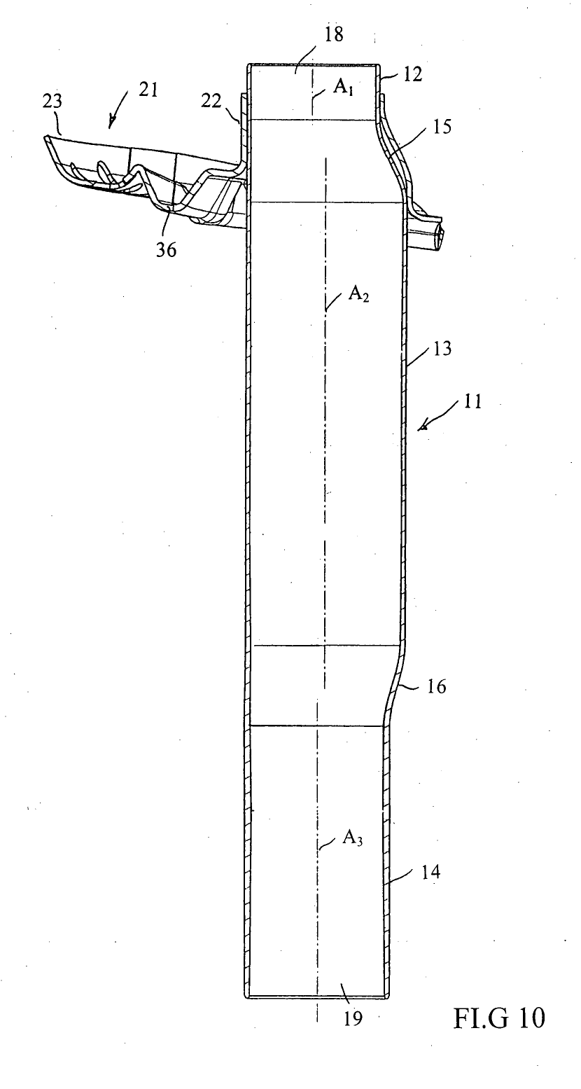

FIG. 10 shows a cross-section of a spring strut tube assembly according to the invention, at a section A-A according to FIG. 9. A continuously straight mantle line 17 is shown against which the continuous mantle line 26 of the seat portion 22 rests in parallel. FIG. 10 shows the respective visual edges as shown in FIG. 9.

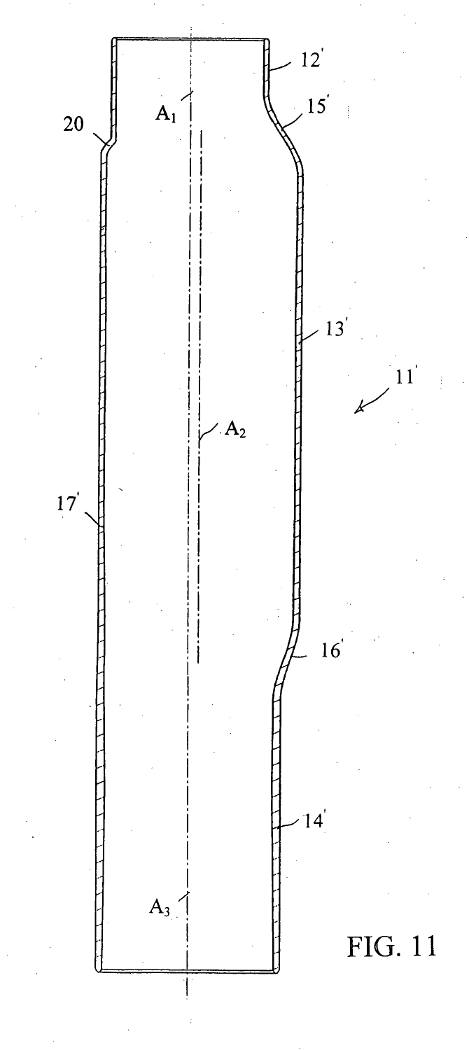

FIG. 11 shows an embodiment of an outer container tube, or a tubular member 11′, according to the invention in a longitudinal section. The tubular member 11′ includes cylindrical portions 12′, 14′, each having at its ends smaller outer diameters. In addition, a central cylindrical portion 13′ is provided with a greater outer diameter. The longitudinal axes A1, A3 of the two cylindrical portions at the ends of the tube are aligned relative to one another. The longitudinal axis A2 of the cylindrical portion 13′ is offset relative to the former two axes. The cylindrical portions are connected to one another by transition portions 15′, 16′, as discussed above.

Since the cylindrical portion 12′ has a smaller diameter than the cylindrical portion 14′, an aligned mantle line 17′ is provided only in the regions of the central cylindrical portion 13′, the transition portion 16′, and the cylindrical portion 14′. In addition, step 20 is provided on a transition portion 15 adjacent to the cylindrical portion 12′.

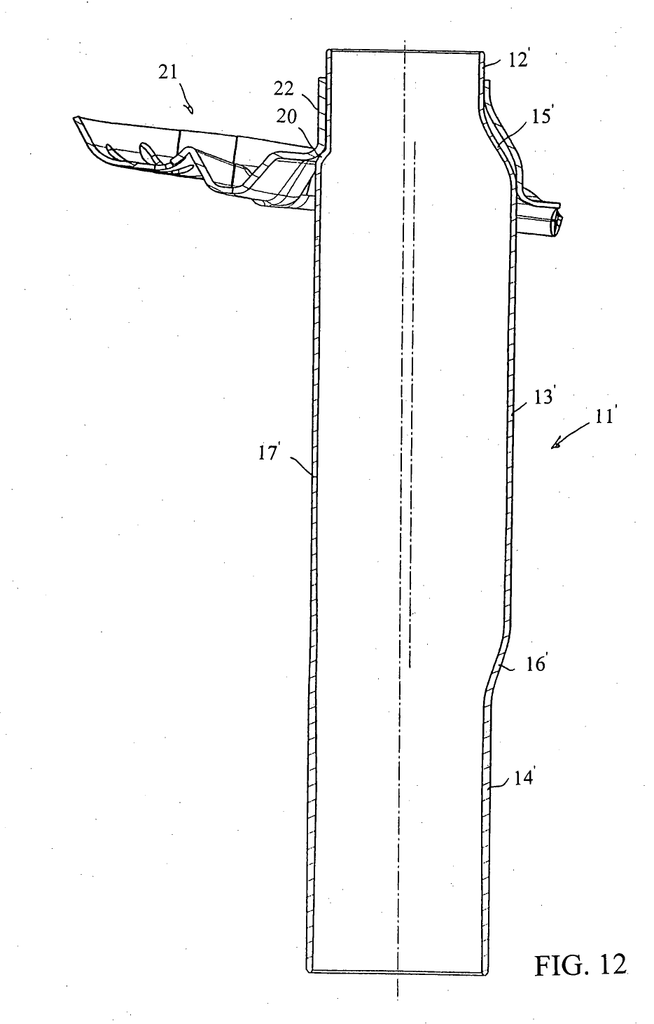

FIG. 12 shows a cross-section of an embodiment of a spring strut tube assembly according to the invention, including an outer container tube, or a tubular member 11′, such as shown in FIG. 11, and a spring plate 21, such as shown in FIGS. 4 to 7. Identical details of the tube have been given the same reference numbers as in FIG. 11. The spring plate 21 is positioned in an axially form-fitting and positive way underneath the seat portion 22 and on the step 20 of the transition portion 15′, so that an improved axial, form-fitting and positive connection is achieved and which is thereby able to accommodate increased axial forces.

Thus, a spring strut tube assembly as illustrated in the drawings, achieves lower production costs, improved strength, while providing a substantially lighter structure than conventional devices.

1. A spring strut tube assembly comprising:
an outer container tube, said container tube being closed by a bottom part at a first end of the tube and having an aperture at the other end of the tube, and
a spring plate, said spring plate being connected to said container tube, at said other end,
wherein said container tube has a wall thickness that is variable in the longitudinal direction of the tube and at least one weld in the longitudinal direction.

2. A spring strut tube assembly according to claim 1, wherein said wall thickness decreases substantially from said bottom part to said aperture.

3. A spring strut tube assembly according to claim 2, wherein said wall thickness decreases substantially whereby a course of the resistance moment in the longitudinal direction corresponds to a course of bending loads under operational conditions.

4. A spring strut tube assembly according to claim 1, wherein said container tube further comprises at least two different cylindrical portions, and at least one transition portion,
wherein each of said at least two different cylindrical portions has a different outer diameter than each other, and wherein at least one of said at least one transition portion is disposed between said at least two different cylindrical portions.

5. A spring strut tube assembly according to claim 1, wherein said container tube further comprises at least two smaller cylindrical portions and an intermediate cylindrical portion,
wherein said at least two smaller cylindrical portions are disposed at the ends of the container tube and have smaller outer diameters than an outer diameter of said intermediate cylindrical portion, and wherein said intermediate cylindrical portion is disposed between said at least two smaller cylindrical portions and has a greater outer diameter than said smaller outer diameters.

6. A spring strut tube assembly according to claim 4, wherein each of said at least two different cylindrical portions further comprise axes and mantle lines, said axes being offset relative to one another, and said mantle lines being aligned relative to one another.

7. A spring strut tube assembly according to claim 6, wherein said at least one weld is aligned with said mantle lines.

8. A spring strut tube assembly according to claim 5, wherein each of said at least two smaller cylindrical portions further comprise axes, said axes being aligned relative to one another.

9. A spring strut tube assembly according to claim 8, wherein a first smaller cylindrical portion of said at least two smaller cylindrical portions has a smaller outer diameter than an outer diameter of a second smaller cylindrical portion of said at least two smaller cylindrical portions, and said first smaller cylindrical portion further comprises a continuous circumferential diameter step with said intermediate cylindrical portion.

10. A spring strut tube assembly according to claim 8, wherein said at least one weld extends in a radial plane through said axes.

11. A spring strut tube assembly according to claim 1, wherein said spring plate further comprises a sleeve-shaped seat portion and an adjoining plate portion.

12. A spring strut tube assembly according to claim 1, wherein said spring plate further comprises a varying wall thickness, and wherein said varying wall thickness comprises a greatest wall thickness disposed at a connection region of said spring plate.

13. A spring strut tube assembly according to claim 1, wherein said spring plate comprises a variable wall thickness, and wherein said variable wall thickness varies in one direction.

14. A spring strut tube assembly according to claim 1, wherein said outer container tube further comprises a transition region, and wherein said spring plate is form-fittingly and positively supported in an axial and rotational direction on said transition region.

15. A spring strut assembly according to claim 1, wherein said spring plate further comprises a support plane, wherein said support plane is disposed at an inclined angle relative to a longitudinal axis of said outer container tube, and wherein said inclined angle deviates from 90°.

16. A spring strut tube assembly according to claim 1, wherein said spring plate is circumferentially delimited substantially circularly, and wherein a center of said spring plate is offset relative to a central axis of said outer container tube.

17. A spring strut tube assembly according to claim 1, wherein a center of said spring plate is disposed between a central axis of said outer container tube and a mantle line of said outer container tube.

18. A spring strut tube assembly according to claim 1, wherein a center of said spring plate is disposed on a side of a central axis of said outer container tube, wherein said side is opposite to a mantle line of said outer container tube.

19. A spring strut tube assembly according to claim 1, wherein said bottom part contains at least one second aperture.

20. A spring strut assembly according to claim 18, wherein said center of said spring plate is further transversely delimited in a straight line on said side positioned opposite said mantle line of said outer container tube.
